(19) United States
(12) Patent Application Publication
(10) Pub. No.: US 2025/0169388 A1
(43) Pub. Date: May 29, 2025

(54) GROUND PRESSURE CONTROL FOR AGRICULTURAL IMPLEMENT

(71) Applicant: ELMER'S WELDING & MANUFACTURING LTD., Altona (CA)

(72) Inventors: Rheal Boileau, Altona (CA); Owen Darrach, Altona (CA); Ray Davis, Altona (CA)

(21) Appl. No.: 18/732,835

(22) Filed: Jun. 4, 2024

Related U.S. Application Data
(60) Provisional application No. 63/603,938, filed on Nov. 29, 2023.

(51) Int. Cl. A01B 63/32; A01B 49/02; F15B 13/04

(52) U.S. Cl. CPC A01B 63/32; F15B 13/0401; A01B 49/02; F15B 2211/526

(57) ABSTRACT

A harrow implement comprises of a tool bar with harrow sections attached in which each section is supported by one or more hydraulic cylinders mounted such that the cylinders force translated through the section provides a substantially constant force to the ground throughout the cylinders travel. A hydraulic pressure control is used such that the hydraulic oil on both sides of each hydraulic cylinder is regulated. The control is operated to vary the pressure differential between sides of the cylinder allowing a continuous range of ground force between zero (sections lifted) and a maximum, transferring tool bar mass to the sections.

This application claims the benefit under 35 U.S.C. 119 (e) of U.S. provisional application Ser. No. 63/603,938, filed Nov. 29, 2023.

### FIELD OF THE INVENTION

The present invention relates to a towed agricultural implement having a toolbar for supporting one or more frame sections thereon carrying ground working tools, for example an agricultural harrow, and more particularly the present invention relates to an agricultural implement having a hydraulic controller for controlling pressure of the ground working tools acting on the ground.

### BACKGROUND

A conventional harrow implement includes a tool bar with a plurality of harrow sections attached running perpendicular to the operating direction of travel. The sections are mounted using a moveable operating linkage, or compliant mechanism such that the harrows tines may bear against the ground while being displaced over uneven ground. The tool bar is commonly comprised of a center section and two wings which are typically rearward folding for transport.

Each harrow section typically consists of a frame extending rearward from the tool bar and connected by an operating linkage. Evenly spaced support bars perpendicular to the operating direction of travel carry a series of evenly spaced flexing harrow tines. The support bars are typically rotatable such that the angle the tines engage the ground may be varied.

The pitch of the harrow sections is typically adjustable by rotating the tool bar, or lifting the front or rear of the frame arms such that the tines bear greater force on the ground at the front or back.

Harrow sections are typically biased such that weight from the tool bar may be transferred to the sections, or vice versa. This system typically uses a sprung configuration or a single pressure control valve that can be configured to vary the amount of bias and control the amount of force applied to the ground.

Harrows typically include provisions which allow for the tool bar to rotate such that the sections can be raised into a vertical position. Once the harrow sections are raised to a vertical position, the wings of the toolbar can be folded rearward for transport, in a rearward trailing configuration.

In one example of a harrow implement, U.S. Pat. No. 5,492,182 by Delaurier discloses a system where the bias force is provided by a spring attached to the tool bar such that forces lifting each section are counteracted by force from the spring transferring weight to the section.

In another example of a harrow implement, U.S. Pat. No. 10,299,421 by Bourgault Industries Ltd. discloses a harrow implement where the bias force is provided by a plurality of hydraulic cylinders connected at one end to the tool bar and at the other end to the harrow section or the operating linkage. A pressure control system is operative to provide regulated pressure to the plurality of hydraulic cylinders at only one side of each cylinder at a time to apply either a controlled lifting force or a controlled down force to each frame section. Additionally, the system is operative to allow the controlled pressure to be varied so that a substantially constant lift or lower pressure applied to the ground may be increased or decreased.

As typical harrow implements of the prior art get heavier for increased soil disruption, their ability to accommodate conditions requiring lighter applications is reduced. Active hydraulic systems of the prior art utilize a plurality of hydraulic cylinders in conjunction with a singular pressure control valve and directional valve operative to provide a substantially constant bias force in the upward or downward directions, with the addition of a neutral force where no pressurized fluid is directed into the cylinders. The system is not operative in the range on either side of neutral in which the pressure control valving is not capable of reducing the pressure any further. As a result of the lower limit on the amount of pressure that can be effective supplied by the pressure control valves, there is a dead range between the variable positive lifting force and the variable positive downforce on either side of a neutral zero-bias position of the hydraulic pressure control system whereby the system is not capable of adjusting the downforce on the tines through a continuous range.

Furthermore, as a typical harrow implement of the prior art move across the varying terrain commonly found on agricultural land the harrow sections move up and down considerably. When hydraulic based systems of the prior art attempt to provide a consistent bias force, they require large amounts of instantaneous hydraulic flow and power from the tractor as the frame sections raise and lower. These requirements create a significant hysteresis, which results in inconsistent harrowing effect on the fields surface as the system systems pressure is greatly influenced by the rate of section travel.

### SUMMARY OF THE INVENTION

According to a first aspect of the invention there is provided a towed agricultural implement comprising:
a tool bar;
ground wheels supporting the tool bar for movement across a ground surface in a forward working direction that is perpendicular to a longitudinal axis of the tool bar;
a plurality of frame sections movably mounted on the tool bar for movement in the forward working direction with the tool bar and carrying ground working tools for engaging the ground surface, each frame section being movably mounted on the tool bar by a respective operating linkage such that the frame section extends rearward from the tool bar and is movable up and down relative to the tool bar independently of other ones of the frame sections;
a hydraulic actuator operatively connected to each operating linkage, each hydraulic actuator including a first port operable to receive pressurized hydraulic fluid to lift the respective frame section relative to the tool bar and a second port operable to receive pressurized hydraulic fluid to lower the respective frame section relative to the tool bar; and
a hydraulic controller assembly including (i) at least one first pressure control valve operative to supply pressurized hydraulic fluid at a substantially constant, first controlled pressure to the first port of each hydraulic actuator to exert an upward bias force to the frame sections, and (ii) at least one second pressure control valve operative to supply pressurized hydraulic fluid at a substantially constant second controlled pressure to the second port of each hydraulic actuator to exert a downward bias force to the frame sections, whereby the hydraulic controller is arranged to exert a net bias force to the frame sections corresponding to a difference between said upward bias force and said downward bias force;
wherein at least one of the first and second controlled pressures is controllably adjustable by the hydraulic controller to vary the net bias force exerted on the frame sections.

In the arrangement described above, the hydraulic controller provides bias forces on the sections of a harrow implement using an active hydraulic source and pressure control valving including one pressure control valve for each side of the plurality of hydraulic cylinders or actuators. In this instance, the pressure differential between each side of the plurality of hydraulic cylinders is operative to control the section bias force, allowing for a smooth, continuous and uninterrupted adjustment range from minimum (sections lifted) to the maximum amount of weight transfer from the tool bar to the sections.

The hydraulic controller is preferably arranged to controllably vary said at least one of the first and second controlled pressures such that the net force is adjustable through a continuous range of bias forces between a maximum lift force and a maximum down force.

Preferably at least the first controlled pressure of said at least one first pressure control valve is adjustable by the hydraulic controller.

The hydraulic controller may be configured to (i) controllably adjust one of the first and second controlled pressures and (ii) maintain another one of the first and second controlled pressures at a fixed pressure value.

Preferably at least one of (i) said at least one first pressure control valve and (ii) said at least one second pressure control valve includes a respective regeneration hydraulic line in communication between a controlled output of the pressure control valve and a regeneration valve, in which the regeneration valve is configured to allow excess pressure at the controlled output above the controlled pressure to be discharged from the controlled output through the regeneration line to another pressurized portion of the hydraulic controller.

The regeneration valve may be configured to discharge the excess pressure of the respective pressure control valve to a pressure supply line supplying hydraulic fluid under pressure to the respective pressure control valve.

Either one or both of said at least one first pressure control valve and/or said at least one second pressure control valve may include the regeneration hydraulic line in communication with the controlled output thereof.

In some instances, both of (i) said at least one first pressure control valve and (ii) said at least one second pressure control valve include the regeneration hydraulic line in communication with the controlled output thereof.

The regeneration valves are preferably configured to discharge the excess pressure at the controlled output of the respective pressure control valve to the controlled output of another one of the pressure control valves. For example, one of the regeneration valves may be configured to discharge the excess pressure at the controlled output of said at least one first pressure control valve to the controlled output of said at least one second pressure control valve, and the other regeneration valve may be configured to discharge the excess pressure at the controlled output of said at least one second pressure control valve to the controlled output of said at least one first pressure control valve.

The regeneration valve may be arranged to discharge the excess pressure at the controlled output of the respective pressure control valve to the controlled output of said another one of the pressure control valves when the excess pressure exceeds the controlled pressured by an amount that is greater than a relief threshold of the regeneration valve.

Each operating linkage may comprise a first link and a second link connected between the toolbar and the respective frame section, wherein the hydraulic actuator comprises a piston cylinder assembly connected between the first link of the operating linkage and one of (i) the second link and (ii) the respective frame section.

The piston cylinder assembly may be connected between the first link of the operating linkage and the respective frame section.

The first link and the second link of each operating linkage may be connected in parallel between the tool bar and the respective frame section, and wherein the first link is below the second link.

The piston cylinder assembly may extend at a downward and forward slope from the respective frame section to the first link.

The piston cylinder assembly may extend at a downward and forward slope throughout a range of motion of the respective frame section relative to the tool bar.

The implement may further include at least one pressure sensor operatively connected to a pressure controlled output of one of the pressure control valves, in which the hydraulic controller assembly is operated in response to pressure within said pressure controlled output sensed by said at least one pressure sensor.

The at least one first pressure control valve may comprise a plurality of first pressure control valves operatively connected to respective ones of the hydraulic actuators, while the at least one second pressure control valve may comprise a plurality of second pressure control valves operatively connected to respective ones of the hydraulic actuators.

When the ground working tools include first tools and second tools that are different from the first tools, the first and second pressure control valves that are associated with the frame sections having the first tools thereon are preferably operated at different net biases forces relative to the first and second pressure control valves that are associated with the frame sections having the second tools thereon.

Each first pressure control valve may be operatively connected to the first ports of a group of the hydraulic actuators in which the first ports of the hydraulic actuators within the group are in open communication with one another. Similarly, each second pressure control valve may be operatively connected to the second ports of the group of the hydraulic actuators in which the second ports of the hydraulic actuators within the group are in open communication with one another.

According to a second independent aspect of the present invention there is provided a towed agricultural implement comprising:
a tool bar;
ground wheels supporting the tool bar for movement across a ground surface in a forward working direction that is perpendicular to a longitudinal axis of the tool bar;
a plurality of frame sections movably mounted on the tool bar for movement in the forward working direction with the tool bar and carrying ground working tools for engaging the ground surface, each frame section being movably mounted on the tool bar by a respective operating linkage such that the frame section extends rearward from the tool bar and is movable up and down relative to the tool bar independently of other ones of the frame sections;
a hydraulic actuator operatively connected to each operating linkage, each hydraulic actuator including a first port operable to receive pressurized hydraulic fluid to lift the respective frame section relative to the tool bar and a second port operable to receive pressurized hydraulic fluid to lower the respective frame section relative to the tool bar; and
a hydraulic controller assembly including at least one pressure control valve operative to supply pressurized hydraulic fluid at a substantially constant, controlled pressure to one of the first or second ports port of each hydraulic actuator to exert a bias force to the frame sections, in which the controlled pressure is controllably adjustable by the hydraulic controller to vary the bias force exerted on the frame sections;
wherein said at least one pressure control valve includes a respective regeneration hydraulic line in communication between a controlled output of the pressure control valve and a regeneration valve, the regeneration valve being configured to allow excess pressure at the controlled output above the controlled pressure to be discharged from the controlled output through the regeneration line to another pressurized portion of the hydraulic controller.

When the hydraulic controller includes a regeneration line with a regeneration valve therein, for example one or more check valves, use of the implement on varying terrain causing external loading of the frame sections such that hydraulic fluid or oil may regenerate or bypass the standard relief function and return to the pressure supply line. This allows hydraulic oil to flow from one pressure regulated side of the system to the other, or to another pressurized line of the hydraulic controller, thus reducing hysteresis of the system, and the volume of oil and power required from the tractor. Additionally, the reduced flow requirements improves responsiveness under changing terrain.

The regeneration valve of said at least one pressure control valve may be configured to discharge the excess pressure of the pressure control valve to a pressure supply line supplying hydraulic fluid under pressure to the respective pressure control valve.

When said at least one pressure control valve includes a first pressure control valve and a second pressure control valve, the regeneration valve may be configured to discharge the excess pressure at the controlled output of the first pressure control valve to the controlled output of the second pressure control valve of the hydraulic controller.

The regeneration valve may be arranged to discharge the excess pressure at the controlled output of the respective pressure control valve when the excess pressure exceeds the controlled pressured by an amount that is greater than a relief threshold of the regeneration valve.

According to another independent aspect of the present invention there is provided a towed agricultural implement comprising:
a tool bar;
ground wheels supporting the tool bar for movement across a ground surface in a forward working direction that is perpendicular to a longitudinal axis of the tool bar;
a plurality of frame sections movably mounted on the tool bar for movement in the forward working direction with the tool bar and carrying ground working tools for engaging the ground surface, each frame section being movably mounted on the tool bar by a respective operating linkage such that the frame section extends rearward from the tool bar and is movable up and down relative to the tool bar independently of other ones of the frame sections;
a hydraulic actuator operatively connected to each operating linkage, each hydraulic actuator including a first port operable to receive pressurized hydraulic fluid to lift the respective frame section relative to the tool bar and a second port operable to receive pressurized hydraulic fluid to lower the respective frame section relative to the tool bar; and
a hydraulic controller assembly including (i) at least one pressure control valve operative to supply pressurized hydraulic fluid at a substantially constant, controlled pressure to one of the first or second ports port of each hydraulic actuator to exert a bias force to the frame sections in which the controlled pressure is controllably adjustable by the hydraulic controller to vary the bias force exerted on the frame sections;
wherein each operating linkage comprises a first link and a second link connected between the toolbar and the respective frame section, wherein the hydraulic actuator comprises a piston cylinder assembly connected between the first link of the operating linkage and one of (i) the second link and (ii) the respective frame section.

In this instance, the operating linkage and cylinder geometry are defined such that under a constant hydraulic pressure differential between opposite sides of the cylinder, the force applied to the ground by the section is substantially constant throughout the range of motion of the frame section relative to the tool bar.

The piston cylinder assembly is preferably connected between the first link of the operating linkage and the respective frame section.

The first link and the second link of each operating linkage may be connected in parallel between the tool bar and the respective frame section, in which the first link is below the second link.

The piston cylinder assembly preferably extends at a downward and forward slope from the respective frame section to the first link. More particularly, the piston cylinder assembly preferably extends at a downward and forward slope throughout a range of motion of the respective frame section relative to the tool bar.

### BRIEF DESCRIPTION OF THE DRAWINGS

Various embodiments of the invention will now be described in conjunction with the accompanying drawings in which:

FIG. 1 is a top plane view of an agricultural harrow implement according to the present invention;

FIG. 2 is a side elevational view of one of the frame sections of the harrow implement according to FIG. 1 with the tool bar shown in a field position and the frame section at a first elevation relative to the tool bar;

FIG. 3 is a side elevation view of the frame section of FIG. 2 with the tool bar shown in the field position and the frame section at a second elevation relative to the tool bar;

FIG. 4 is a side elevation view of the frame section of FIG. 2 with the tool bar shown rotated into a transport position;

FIG. 5 is a perspective view of the operating linkage of the frame section at the second elevation according to FIG. 3;

FIG. 6 is a schematic representation of the forces acting upon the frame section according to FIG. 2;

FIG. 7 is a schematic representation of the hydraulic controller according to a first embodiment of the present invention;

FIG. 8 is a schematic representation of the hydraulic controller according to a second embodiment of the present invention;

FIG. 9 is a schematic representation of the hydraulic controller according to a third embodiment of the present invention;

FIG. 10 is a schematic representation of the hydraulic controller according to a fourth embodiment of the present invention; and

FIG. 11 shows a possible situation where the responsiveness of the ground pressure hydraulic system of the implement of FIG. 1 is relied upon for maintaining the field finish through varying terrain.

In the drawings like characters of reference indicate corresponding parts in the different figures.

### DETAILED DESCRIPTION

Referring to the accompanying figures, there is illustrated an agricultural harrow implement generally indicated by reference numeral 10.

According to the illustrated embodiment, the harrow implement 10 has a main frame comprised of a centre section 12 and two wing sections 14 which protrude laterally outward in opposing directions from the centre frame perpendicularly to a forward working direction of the implement in a field configuration of the implement. A hitching frame 16 is coupled primarily to the centre frame section to extend forwardly therefrom in the forward working direction to form a towed connection with a working vehicle such as an agricultural tractor to tow the implement 10 forwardly across the ground in the forward working direction.

The implement includes a toolbar for supporting various ground working devices thereon as described in further detail below. In the illustrated embodiment the toolbar includes a centre toolbar section 18 primarily defining the centre section 12 of the frame and two wing toolbar sections 20 primarily defining the respective wing sections 14 of the frame. In the field configuration, the toolbar sections are aligned with one another across the full width of the implement so as to extend perpendicularly to the forward working direction.

Each of the wing sections 14 are pivotally coupled to the centre frame section by a suitable pivot coupling 22 having a horizontal axis in the forward working direction in the field configuration to enable the wing sections to pivotally float up and down relative to the centre frame section to follow ground contours as the implement is towed across the ground in the forward working direction. The toolbar sections which primarily define the sections of the main frame can be rotated about a respective longitudinal axis of the toolbar through 90 degrees from the field configuration so that the pivot axes of the pivot couplings 22 are oriented vertically to accommodate displacement of the implement into a transport configuration. Once the toolbar has been rotated through 90 degrees from the field configuration, forward movement of the implement with the towing vehicle causes the wing sections 14 to be folded rearwardly into a rearward trailing configuration extending parallel to the forward working direction. Rotation of the toolbar through 90 degrees into the transport configuration is shown in FIG. 4.

A set of wheels 24 are coupled to the various sections of the main frame to support the implement for rolling movement across the ground in the forward working direction in the field configuration. The wheels can be reoriented for rolling in the forward working direction when the wing sections extend rearward in the transport configuration to support the frame sections for rolling movement across the ground in the transport configuration as well.

The illustrated embodiment, the implement includes a plurality of harrow frame sections 26 movably mounted on the toolbar for movement in the forward working direction with the toolbar. Each harrow frame section 26 is connected to a respective section of the toolbar by a respective operating linkage 28 such that the harrow frame section extends rearward from the toolbar and is movable up and down relative to the toolbar independently of other ones of the frame sections. Each harrow frame section is arranged to carry a plurality of ground working tools for engaging the ground surface across which the implement is towed as described in further detail below.

The harrow frame sections 26 are movable with the toolbar sections as the toolbar is rotated from the field configuration to the transport configuration such that the harrow frame sections extend upwardly from the respective toolbar sections in the transport configuration as shown in FIG. 4.

The operating linkage according to the illustrated embodiment generally comprises at least one four bar linkage including a lower first link 30 and an upper second link 32 spaced above the lower first link 30 such that the links are parallel to one another. The first and second links are pivoted at forward ends at vertically spaced apart positions on a suitable mounting bracket 34 that is fixed onto the toolbar to rotate with the toolbar between field and transport configurations. Similarly, the first and second links 30 and 32 are pivoted at rear ends at vertically spaced apart positions on a corresponding mounting frame 36 that is fixed onto the respective harrow frame section 26 associated with that operating linkage 28. A pair of the four bar linkages as described above are mounted between each harrow frame section 26 and the respective toolbar section at laterally spaced apart positions along the toolbar in the field configuration.

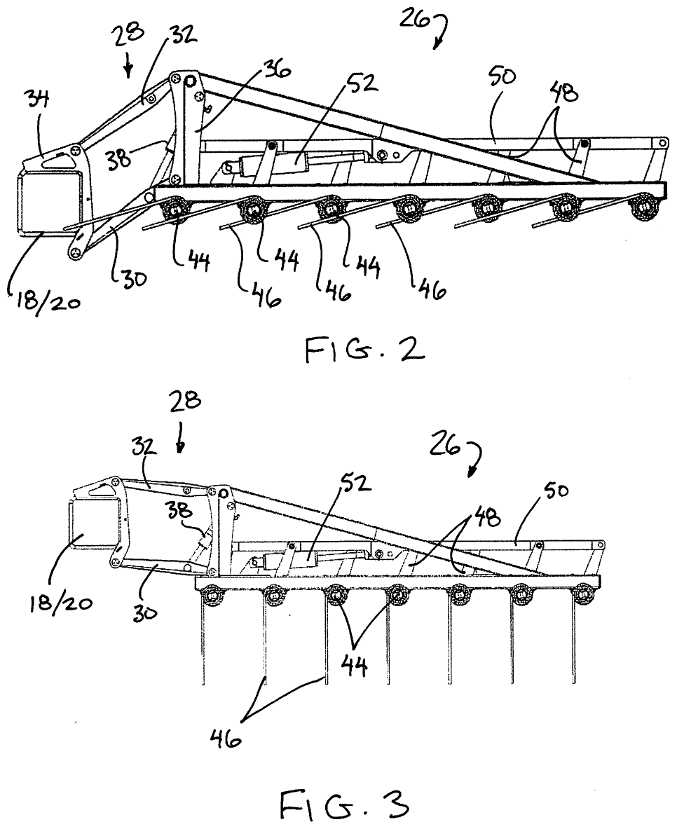

As a result of the parallel configuration of the first and second links 30 and 32, the harrow frame section 26 maintains a generally level and horizontal orientation while being displaced up and down through a range of positions relative to the toolbar. In the uppermost position of each harrow frame section, the parallel links are sloped upwardly and rearwardly as shown in FIG. 2. As shown in an intermediate position in FIG. 3, each harrow frame section 26 can also be lowered from the uppermost position of FIG. 2 to a lower position in which the parallel links 30 and 32 are sloped downwardly and rearwardly.

At least one hydraulic actuator 38 is associated with each harrow frame section 26 to control the upward and downward movement as well as the amount of pressure of the ground engaging tools engaged upon the ground. In the illustrated embodiment, one hydraulic actuator 38 is associated with each of the pair of four bar linkages defining the operating linkage 28 of a respective harrow frame section 26.

Each hydraulic actuator 38 comprises a piston cylinder assembly which can be linearly extended and retracted in overall length. In the illustrated embodiment, each actuator is pivotally mounted at a cylinder end on the mounting frame 36 of the harrow frame section while the piston end of the hydraulic actuator is pivotally mounted on the lower first link of the parallel links at an intermediate location spaced inwardly from the pivotal connections at both opposing ends of the lower first link 30. In the illustrated embodiment, each hydraulic actuator 38 remains sloped generally downwardly and forwardly through the full range of pivotal movement of the harrow frame section up and down relative to the toolbar in the field configuration. In further embodiments however, the orientation of the actuators 38 and the mounting locations relative to the operating linkage 28 can be varied.

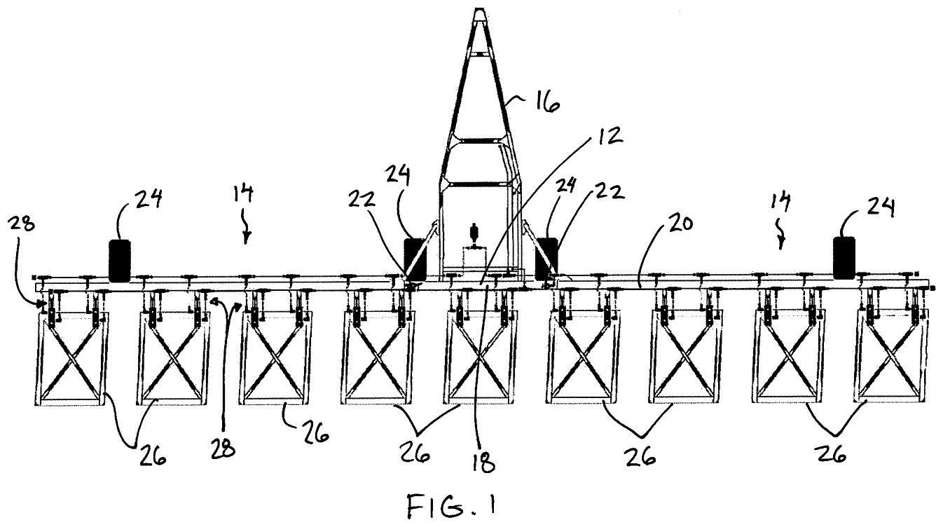

The illustration of FIG. 1 shows how a plurality of hydraulic cylinders may be connected to a plurality of sections such that one hydraulic control mechanism may be used to control all of the actuators 38 of the implement. In further embodiments, independent hydraulic control systems may be used to control different sections of the implement as describe din further detail below.

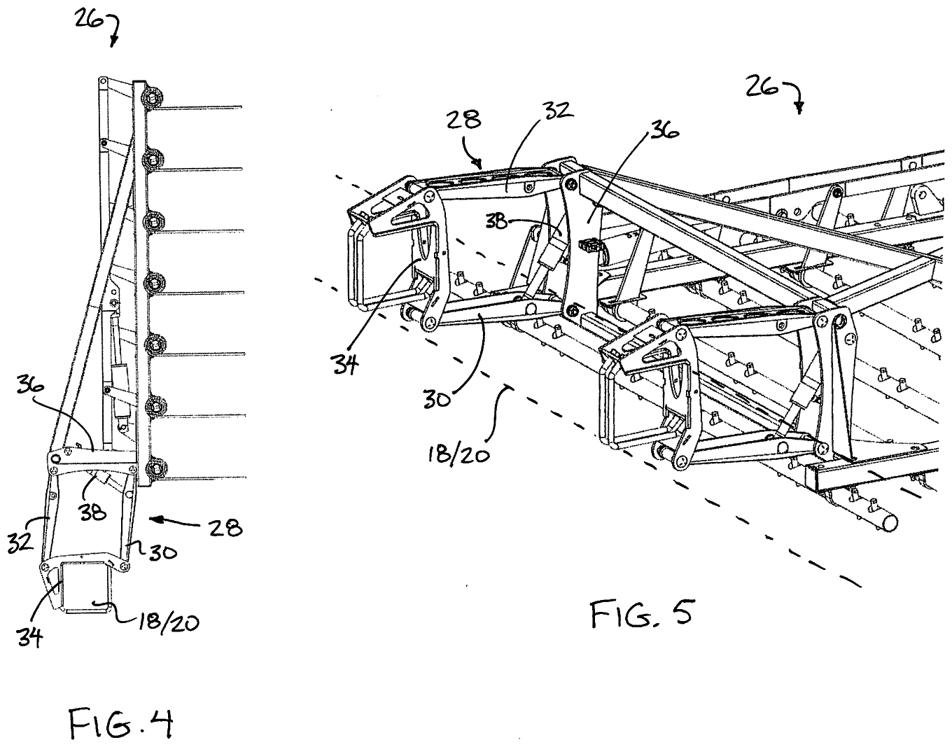

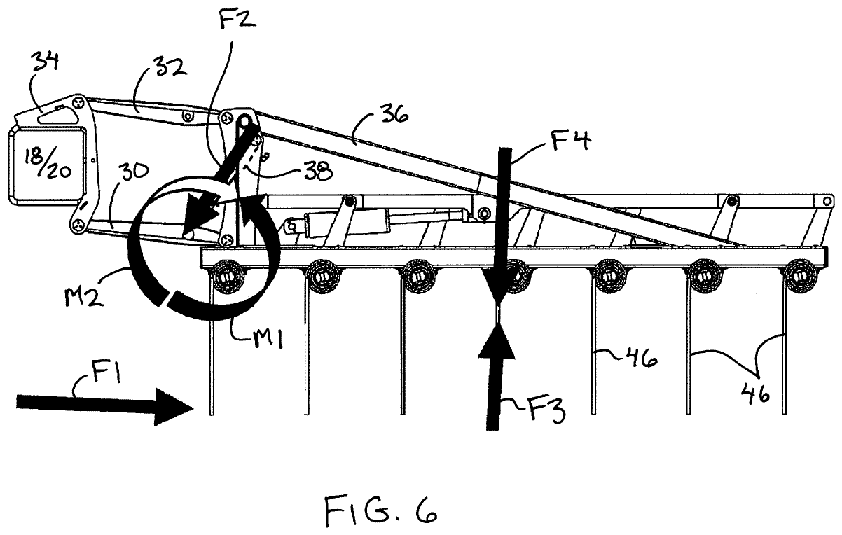

FIGS. 2 through 5 show how a first embodiment of the harrow section utilizes hydraulic ground pressure control. While critical to the linearity of a system the exact placement of the hydraulic cylinder is dependant on the overall system geometry, required amount of travel, external loading, and other factors which may make other orientations more optimal in other applications and configurations.

FIG. 6 shows a simplified version of the forces applied to a harrow section which are currently known to affect the linearity of forces applied to the ground by the down pressure system. The arrow F1 represents the horizontal force or draft created by pulling the implement across the ground, while the arrow M1 represents the moment created about the section by the horizontal force or draft applied to the section. This moment acts such that the section is forced upwards away from the ground.

The arrow F2 to represents the force (positive or negative relative to the arrow) applied by the down pressure systems cylinders acting between the section and the lower parallel link in a slightly forward direction. The arrow M2 represents the moment created by the portion of force applied by the down pressure system acting in the forward direction and the internal reactionary forces created within the linkage, partially acting to counteract the moment created by the horizontal or draft forces. The arrow F3 represents the vertical forces applied to the harrow section by the ground. The arrow F4 represents the amount of force applied by the down pressure system in the substantially downward direction.

As the section is raised and lowered by following the ground the angle of the parallel links relative to the section is modified. The down force cylinder angle & length and location of the applied horizontal force or draft also move relative to the angle of the parallel links. The down force cylinder positioned within the linkage such that the throughout these changes in position the moments created by the down pressure system and draft force largely cancel out, leaving a substantially constant vertical force applied to the ground through the section regardless of its position.

A similar effect of the cancelation of moments created by cylinder forces is possible by positioning the actuator between the parallel links. Advantages and disadvantages between the 2 systems are primarily related to packaging, or actuator force required during operation.

As described above, each hydraulic actuator 38 comprises a hydraulic piston cylinder assembly including a cylinder receiving a piston slidably therein to extend and retract the overall length of the assembly in a linear direction. Each cylinder includes a first port 40 nearest to the cylinder end of the assembly for receiving pressurized fluid therein to extend the piston from the cylinder which acts in a direction to provide a lifting force to the respective harrow frame section according to the illustrated embodiment. Furthermore, each cylinder includes a second port 42 nearest to the piston end of the assembly for receiving pressurized fluid therein to retract the piston into the cylinder which acts in a direction to provide lowering force to the respective harrow frame section according to the illustrated embodiment.

A hydraulic controller is provided on the implement to receive a supply of pressurized hydraulic fluid from the towing vehicle and to regulate the supplied flow of pressurized hydraulic fluid to simultaneously deliver the hydraulic fluid to the hydraulic actuators 38 at a first controlled pressure delivered to the first ports 40 of the hydraulic actuators 38 and at a second controlled pressure delivered to the second ports 42 of the hydraulic actuators 38. Details of the hydraulic controller will be described in further detail below.

All of the first ports of the various actuators may be fluidly linked to enable a lateral flow of hydraulic fluid between the first ports of all of the actuators 38 according to the illustrated embodiment of FIG. 1. Likewise, all of the second ports of the various actuators 38 may be fluidly linked to enable a lateral flow of hydraulic fluid between the second ports of all of the actuators according to the illustrated embodiment of FIG. 1.

In the illustrated embodiments, each of the harrow frame sections 26 includes a rectangular frame which is supported in a generally horizontal configuration when in the field position. A plurality of tine support bars 44 are mounted on the frame of each harrow frame section 26 so that the support bars are parallel to one another and spaced apart from one another in the forward working direction of the implement. Each tine support bar 44 mounts a plurality of tines 46 thereon which are laterally spaced apart along the length of each support bar. The tines 46 are supported by respective springs so as to be oriented generally parallel to one another while allowing some flexing movement by deflecting with the spring in response to varying pressure or ground contours as the implement is displaced forwardly across the ground. The approximate angle of the tines relative to the ground can be commonly adjusted by rotating the support bars 44 upon which the tines are supported. In this regard, each support bar 44 includes a crank 48 extending radially therefrom for pivotal connection to a connecting arm 50 extending generally parallel to the forward working direction. As the connecting arm 50 is displaced forwardly and rearwardly, the support bars 40 rotate together which in turn rotates the tines together to commonly adjust the tine angle relative to the frame of the harrow frame section. A tine actuator 52 is operatively connected between the frame of the harrow frame section and the connecting arm 50 to displace the connecting arm 50 forwardly and rearwardly as the tine actuator 52 is extended and retracted using hydraulic controls of the towing vehicle.

The hydraulic controller of the implement in each instance comprises a one or more first pressure control valves 54 that are each associated with one or more of the first ports 40 of the actuators 38 and one or more second pressure control valves 56 that are each associated with one or more of the second ports 42 of the actuators 38 of the implement. Each of the first and second pressure control valves 54 and 56 includes a supply input 58 that is in communication with a supply line 60 that delivers a flow of pressurized hydraulic fluid from the tractor, a return output 62 that is in communication with a return line 62 that returns a flow of hydraulic fluid to the tractor, and a controlled output 66 delivering a flow of hydraulic fluid at a controlled pressure dictated by the adjustable setpoint associated with the respective valve. According to various embodiments described herein, the setpoint of the control valves 54 and 56 and thus the controlled pressure delivered from the controlled output 66 thereof may be electronically controllable using controls in the operator cab of the towing vehicle or may be manually set on the implement or using manual controls of the towing vehicle.

A computer controller may be associated with the hydraulic controller enabling the setpoints of the pressure control valves to be adjusted according to programmed criteria. In this instance, one or more pressure sensors may be provided within the hydraulic control system to monitor pressure at one or more controlled outputs 66 of the pressure control valves such that the computer controller can automatically adjust the setpoint associated with any of the pressure control valves to achieve a desired pressure output at the associated controlled output 66 of the valves.

In the illustrated embodiment according to FIG. 1, a single first pressure control valve 54 may be associated with the first ports 40 of all of the hydraulic actuators 38 and a single second pressure control valve 56 may be associated with the second ports of all of the hydraulic actuators 38. In other embodiments however each first pressure control valve 54 among a plurality of the valves may be associated with the first port of an associated actuator 38 or a subgroup of actuators 38, while each second pressure control valve 56 and among a plurality of the valves may be associated with the second port of an associated actuator 38 or a subgroup of actuators 38. In some instances, all of the actuators associated with one section of the frame such as a wing section may be associated with one first pressure control valve 54 and one second pressure control valve 56 for the group of actuators, while other pressure control valves are associated with other frame sections.

As described herein, the first controlled pressure applied by the first pressure control valve acts to extend the associated actuator 38 while the second controlled pressure applied by the second pressure control valve acts to retract the associated actuator 38. In this manner, the difference between the first and second controlled pressures determines the net force applied by the actuator 38 to be extended or retracted which in turn applies a net downward or upward bias through the operating linkage to the associated harrow frame section.

According to the preferred embodiments, the hydraulic controller assembly includes (i) at least one first pressure control valve operative to supply pressurized hydraulic fluid at a substantially constant, first controlled pressure to the first port of each hydraulic actuator to exert an upward bias force to the frame sections, and (ii) at least one second pressure control valve operative to supply pressurized hydraulic fluid at a substantially constant second controlled pressure to the second port of each hydraulic actuator to exert a downward bias force to the frame sections. In this manner, the hydraulic controller is arranged to exert a net bias force to the frame sections corresponding to a difference between the noted upward bias force and the noted downward bias force. One or both of the first and second controlled pressures is controllably adjustable by the hydraulic controller to vary the net bias force exerted on the frame sections.

In other instances, the frame sections may be provided on the implement carrying different types of ground working tools such that the actuators associated with a first type of ground working tools are operated by a dedicated pairing of a first pressure control valve 54 and a second pressure control valve 56, whereas the actuators associated with a second type of ground working tools are operated by their own dedicated pairing of a first pressure control valve 54 and a second pressure control valve 56. This allows the different types of ground working tools to be operated at different applied pressures against the ground as the implement is displaced across the ground.

In the illustrated embodiments described herein, the hydraulic controller is further provided with at least one regeneration hydraulic line 70 in fluid communication with the controlled output of at least one of the pressure control valves 54 and 56 to redirect excess pressure at the controlled output to another pressurized portion of the hydraulic controller. A regeneration valve 72 is connected in line with the regeneration line 70 to control the discharge of excess pressure from the controlled output.

The regeneration valve 72 may be set to discharge any excess pressure at the controlled output of the respective valve that exceeds the setpoint value associated with the valve. In this instance, the regeneration valve 72 may comprise a simple check valve that only allows flow in one direction to be discharged from the controlled output of the associated pressure control valve to another pressurized portion of the hydraulic controller.

Alternatively, the regeneration valve 72 may be configured to discharge only excess pressure that exceeds a threshold amount above the setpoint pressure of the valve. In this instance, the regeneration valve 72 may be a logic control valve that opens and closes when pressure amounts are met at prescribed locations within the hydraulic system. The threshold amount may be determined by a programmed set point when the valves are electronically controlled, or alternatively the threshold amount may correspond to the force required to release a spring that controls the opening and closing of the regeneration valve 72.

Turning now to a first embodiment of the hydraulic controller as shown in FIG. 7, in this instance one of the regeneration lines 70 is in communication with the controlled output of each of the first and second pressure control valves to direct excess hydraulic fluid corresponding to pressure at the controlled output 66 which exceeds the setpoint of the hydraulic valve into the supply input 62 of the same pressure control valve. The regeneration valve 72 in this instance comprises a check valve which only allows hydraulic fluid to flow in one direction from the controlled output 66 to the supply input 62 of the respective pressure control valve 54 or 56 associated therewith.

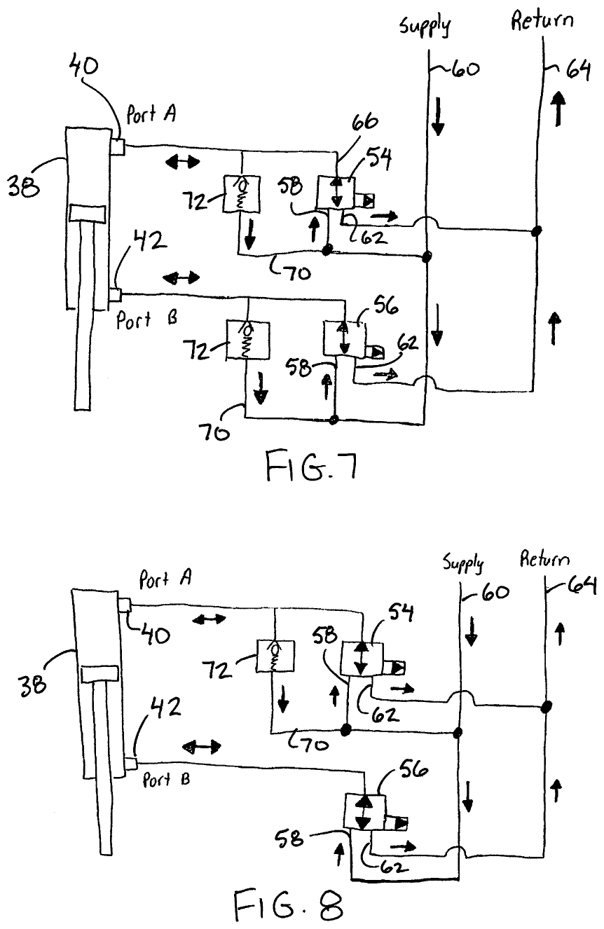

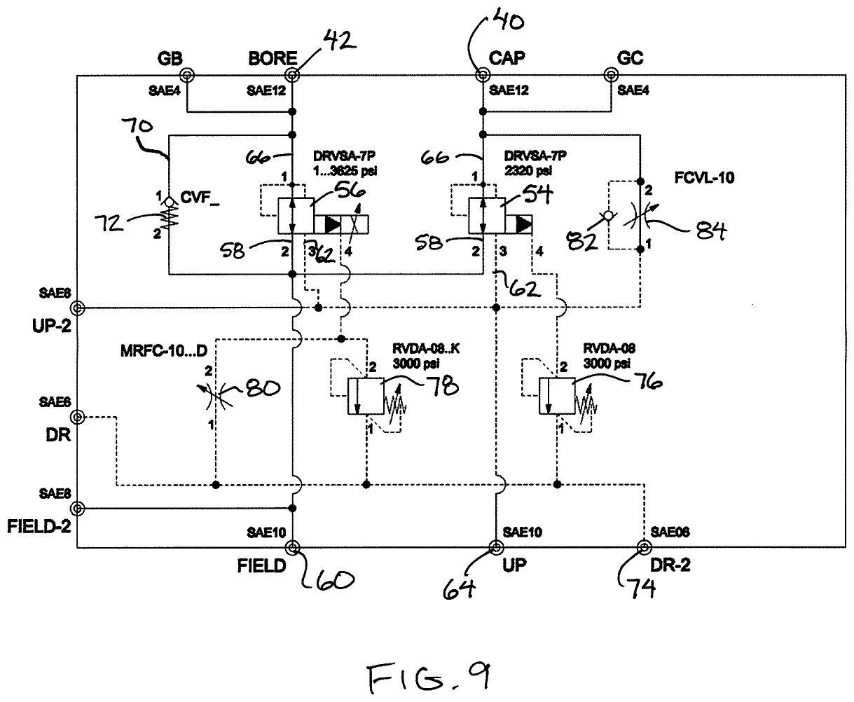

According to a second embodiment of the hydraulic controller as shown in FIG. 8, in this instance only the first pressure control valves 54 includes one of the regeneration lines 70 associated therewith. In this instance, the regeneration line 70 again includes a regeneration valve 72 connected in line with the regeneration line in the form of a check valve which only allows hydraulic fluid to flow in one direction from the controlled output 66 to the supply input 62 of the respective pressure control valve 54. The first pressure control valve 54 in this instance is associated with the first ports 40 of the hydraulic actuators 38 corresponding to providing a lifting force to the respective harrow frame sections associated with the actuator.

In further embodiments however it is also feasible to provide a regeneration line 70 and associated regeneration valve 72 that are associated only with the second pressure control valves 56.

These configurations allow oil from the cylinders to bypass the pressure control valve under external loading to return to the pressurized supply line where is able to enter the pressure control valve on the other side of the system. This reduces the amount of oil and therefore power required from the supply while also reducing the systems hysteresis, improving responsiveness.

It is advantageous to use regeneration on one or both sides of the circuit depending on the exact configuration of the implement, sensitivity of the valving, and risk associated with a delayed or slow response due to oil starvation or PR valve limitations. The regeneration valves can reduce the workload or flow rates through the systems PR valves allowing for smaller valves, reduced pressure drop, and or improved responsiveness.

When positioned such that the regeneration valve activates when the sections are forced upwards, the system can respond faster, minimizing overworking the soil, and reducing the risk of overload damage to the system.

When positioned such that the regeneration valve activates when the sections are pulled down by gravity, the system can respond faster, minimizing underworking the soil, and reducing the risk of loosing contact with the ground and dropping crop residue.

When used together the system would maintain the benefits in each direction.

If a single valve is used it may be advantageous to use it on the bore side or larger displacement side of the systems hydraulic cylinders. Somewhat reducing the workload of the pressure control valve on this side of the system may further improve responsiveness. However, this is not a requirement, and the other benefits described above may outweigh the benefit here.

Turning now to FIG. 9, a further embodiment of the pressure control valve will now be described in further detail. The hydraulic controller in this instance includes additional valving for manual override control and accumulator venting.

The ports labelled Field 2, Up 2, and DR in FIG. 9 are auxiliary passthrough ports allowing flow from the supply to additional manifolds or functions.

The Field port is the pressurized input that is in fluid communication with the supply line 60 of the hydraulic controller while the UP port is the return port that is in fluid communication with the return line 62 of the hydraulic controller. An additional DR port corresponds to a low pressure or case drain return line 74 of the hydraulic controller.

The supply port connected to the supply line 60 and the return port connected to the return line 62 may be reversed by switching into a manual override for lifting the harrow frame sections into a transportable position of the harrow frame sections relative to the tool bar as shown in FIG. 2.

In this instance the first pressure control valve 54 associated with providing a lifting force at the first port 40 of the actuators is generally maintained in operation at a fixed setpoint pressure value to deliver a first controlled pressure that is substantially constant to the first port 40 of the actuators 38. A pressure relief valve 76 controls the pressure setting of first pressure control valve 54 at the fixed set point value.

The second pressure control valve 56 controls the pressure and flow of hydraulic fluid in and out of the second ports 42 of the actuators 38. The second pressure control valve 56 in this instance has an electronically controlled setpoint value that can be readily adjusted using operator controls in the operator cab of the tractor through an electronic controller. The operator adjusts this pressure control value through a range of values so that the downward bias force applied by the hydraulic actuator is adjustable while the upward bias force remains fixed to effectively vary the overall net bias force exerted on the frame sections by the hydraulic actuator through a continuous range of pressure values from a maximum downward bias force to a maximum upward bias force as shown in table 1 below.

As described above, the second pressure control valve 56 in this instance controls the pressure and flow of oil in and out of the second port 42 corresponding to applying a downforce to the harrow frame sections. This valve is controlled electronically during normal operation. The pressure relief valve 78 controls the pressure setting of pressure control valve 56 at a manually set fixed valve for operation without electronics. The hydraulic valve 80 communicates with a hydraulic line between the pressure relief valve 78 and the pressure setting of the pressure control valve 56 and must be closed to allow the pressure relief valve 78 to control the pressure control valve 56, and must be open to allow for electronic control of the pressure setting of the pressure control valve 56.

The regeneration line 70 and the corresponding regeneration valve 72 in this instance allows regeneration of hydraulic fluid at an excess pressure from the controlled output 66 of the pressure control valve 56 to the supply line 60 at the supply input 62 of the pressure control valve 56, bypassing the pressure control valve 56.

In this case the circuit allows regeneration from the larger displacement bore side of the hydraulic cylinders to the supply side under external loading. This allows the harrow to react faster when raising the sections under external loads which helps to prevent damage to the implement and the overworking of the soil.

The check valve 82 in connection between the controlled output 66 of the first pressure control valve 54 and the return line 64 allows the tractor to reverse flow to achieve a transportable position with the sections lifted by allowing excess pressure in the return line 64 in the reverse switching mode to be directed into the lifting side of the actuators 38. A manual override 84 included on the valve allows pressure stored in an accumulator to bypass the associated check valve 82 during maintenance.

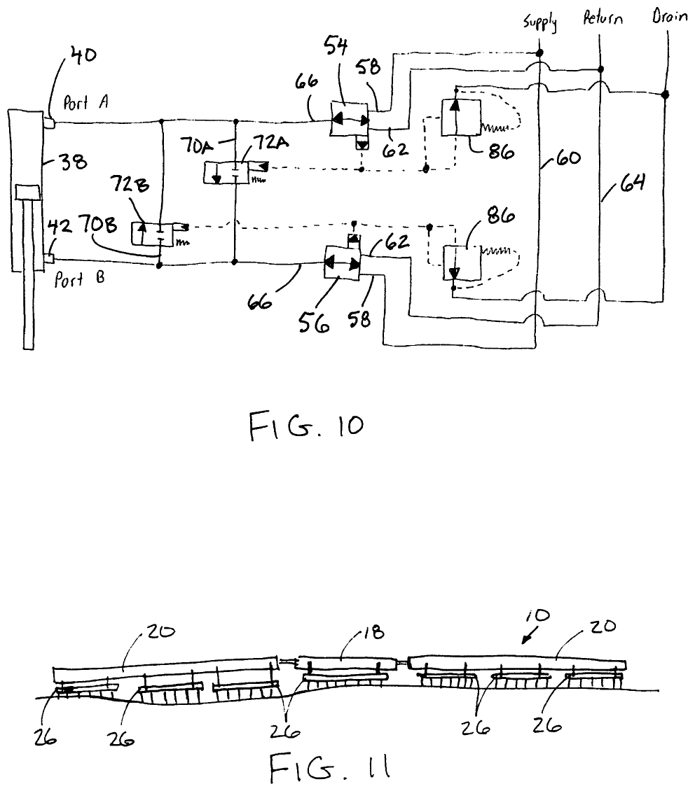

Turning now to a further embodiment of the hydraulic controller as illustrated in FIG. 10, in this instance a first regeneration line 70A is connected between the controlled output of the first pressure control valve 54 and the controlled output of the second pressure control valve 56, and includes a first regeneration valve 72A connected in line therewith. In addition, a second regeneration line 70B is connected between the controlled output of the first pressure control valve 54 and the controlled output of the second pressure control valve 56, and includes a second regeneration valve 70 to be connected in line therewith. The regeneration lines allow oil to bypass directly from one side of the circuit to the other with a significant improvement in the sensitivity to changes in pressure. In this case pressure relief valves 86 are used to set the desired operating pressure on each side of the system. Furthermore, the pressure control valves 54 and 56 have their operating pressure set by the relief valve that controls the output pressure and flow from each side of the system. The regeneration valves 70A and 70B in this instance are piloted directional elements that are used to allow oil to flow directly from one side of the system to the other. Each piloted directional element 70A and 70B is set by the pressure of its corresponding relief valve plus an offset value or threshold amount determined by a spring, or internal valve geometry. The piloted directional elements will each open if the system pressure on one side of the system exceeds the relief valve setting plus the offset threshold amount. The offset is set such that oil is substantially prevented from moving between sides of the system during regular operation in relatively level ground. In more challenging terrain, or crossing ditches, the rapid and potentially extreme changes in external loading cause pressure to increase overcoming the offset threshold amount and allowing oil to move rapidly to the other side of the system until pressures normalize.

A similar effect could be accomplished by using electronically controlled valves, where the setting of the directional element and setting of the pressure control valve 54 or 56 are aligned such that the desired pressure offset is achieved for the regeneration valve opening and eliminating the need for relief valves.

A further possibility would be to implement pressure sensors and a singular bidirectional valve which may be operated based on live pressure readings to optimize the responsiveness of the system. With that said pressure sensors could be utilized on any of these circuits combined with partial or full electronic control such that the system is operable with increased accuracy, responsiveness, and or reduced reliance on calibrations.

Table 1 below shows with a hypothetical approximate range of ground pressure settings possible utilizing technology of the prior art compared to our new developments. The missing possible settings as seen in the table for the prior art are commonly in the middle of a desirable range of settings which makes fine tuning the implement in this area difficult or impossible in challenging conditions. The dual pressure control system is able to maintain a continuous range of adjustment within the same minimum to maximum range.

| Setting | Prior Art | Our Disclosure |
|---|---|---|
| Minimum | 1 | 1 |
| | 2 | 2 |
| | 3 | 3 |
| | 4 | 4 |
| | n/a | 5 |
| Neutral | 6 | 6 |
| | n/a | 7 |
| | 8 | 8 |
| | 9 | 9 |
| | 10 | 10 |
| Maximum | 11 | 11 |

Table 1 shows an approximate range of settings possible with prior art and our disclosure.

FIG. 11 shows a possible situation where the responsiveness of the ground pressure hydraulic system is critical for maintaining the field finish through varying terrain. Crossing this type of obstacle with a system which is slow to react can result in an uneven finish (extremely light and or heavy) which results in dropping clumps of crop residue.

Since various modifications can be made in the invention as herein above described, and many apparently widely different embodiments of same made, it is intended that all matter contained in the accompanying specification shall be interpreted as illustrative only and not in a limiting sense.

1. A towed agricultural implement comprising:
a tool bar;
ground wheels supporting the tool bar for movement across a ground surface in a forward working direction that is perpendicular to a longitudinal axis of the tool bar;
a plurality of frame sections movably mounted on the tool bar for movement in the forward working direction with the tool bar and carrying ground working tools for engaging the ground surface, each frame section being movably mounted on the tool bar by a respective operating linkage such that the frame section extends rearward from the tool bar and is movable up and down relative to the tool bar independently of other ones of the frame sections;
a hydraulic actuator operatively connected to each operating linkage, each hydraulic actuator including a first port operable to receive pressurized hydraulic fluid to lift the respective frame section relative to the tool bar and a second port operable to receive pressurized hydraulic fluid to lower the respective frame section relative to the tool bar; and
a hydraulic controller assembly including (i) at least one first pressure control valve operative to supply pressurized hydraulic fluid at a substantially constant, first controlled pressure to the first port of each hydraulic actuator to exert an upward bias force to the frame sections, and (ii) at least one second pressure control valve operative to supply pressurized hydraulic fluid at a substantially constant second controlled pressure to the second port of each hydraulic actuator to exert a downward bias force to the frame sections, whereby the hydraulic controller is arranged to exert a net bias force to the frame sections corresponding to a difference between said upward bias force and said downward bias force;
wherein at least one of the first and second controlled pressures is controllably adjustable by the hydraulic controller to vary the net bias force exerted on the frame sections.

2. The implement according to claim 1 wherein the hydraulic controller is arranged to controllably vary said at least one of the first and second controlled pressures such that the net force is adjustable through a continuous range of bias forces between a maximum lift force and a maximum down force.

3. The implement according to claim 1 wherein at least the first controlled pressure of said at least one first pressure control valve is adjustable by the hydraulic controller.

4. The implement according to claim 1 wherein the hydraulic controller is configured to (i) controllably adjust one of the first and second controlled pressures and (ii) maintain another one of the first and second controlled pressures at a fixed pressure value.

5. The implement according to claim 1 wherein at least one of (i) said at least one first pressure control valve and (ii) said at least one second pressure control valve includes a respective regeneration hydraulic line in communication between a controlled output of the pressure control valve and a regeneration valve, the regeneration valve being configured to allow excess pressure at the controlled output above the controlled pressure to be discharged from the controlled output through the regeneration line to another pressurized portion of the hydraulic controller.

6. The implement according to claim 5 wherein the regeneration valve is configured to discharge the excess pressure of the respective pressure control valve to a pressure supply line supplying hydraulic fluid under pressure to the respective pressure control valve.

7. The implement according to claim 6 wherein said at least one first pressure control valve includes the regeneration hydraulic line in communication with the controlled output thereof.

8. The implement according to claim 6 wherein said at least one second pressure control valve includes the regeneration hydraulic line in communication with the controlled output thereof.

9. The implement according to claim 1 wherein both of (i) said at least one first pressure control valve and (ii) said at least one second pressure control valve include the regeneration hydraulic line in communication with the controlled output thereof.

10. The implement according to claim 9 wherein the regeneration valve is configured to discharge the excess pressure at the controlled output of the respective pressure control valve to the controlled output of another one of the pressure control valves.

11. The implement according to claim 10 wherein the regeneration valve is configured to discharge the excess pressure at the controlled output of said at least one first pressure control valve to the controlled output of said at least one second pressure control valve.

12. The implement according to claim 10 wherein the regeneration valve is configured to discharge the excess pressure at the controlled output of said at least one second pressure control valve to the controlled output of said at least one first pressure control valve.

13. The implement according to claim 10 wherein the regeneration valve is arranged to discharge the excess pressure at the controlled output of the respective pressure control valve to the controlled output of said another one of the pressure control valves when the excess pressure exceeds the controlled pressured by an amount that is greater than a relief threshold of the regeneration valve.

14. The implement according to claim 1 wherein each operating linkage comprises a first link and a second link connected between the toolbar and the respective frame section, wherein the hydraulic actuator comprises a piston cylinder assembly connected between the first link of the operating linkage and one of (i) the second link and (ii) the respective frame section.

15. The implement according to claim 14 wherein the piston cylinder assembly is connected between the first link of the operating linkage and the respective frame section.

16. The implement according to claim 14 wherein the first link and the second link of each operating linkage are connected in parallel between the tool bar and the respective frame section, and wherein the first link is below the second link.

17. The implement according to claim 14 wherein the piston cylinder assembly extends at a downward and forward slope from the respective frame section to the first link.

18. The implement according to claim 14 wherein the piston cylinder assembly extends at a downward and forward slope throughout a range of motion of the respective frame section relative to the tool bar.

19. The implement according to claim 1 further comprising at least one pressure sensor operatively connected to a pressure controlled output of one of the pressure control valves and wherein the hydraulic controller assembly is operated in response to pressure within said pressure controlled output sensed by said at least one pressure sensor.

20. The implement according to claim 1 wherein said at least one first pressure control valve comprises a plurality of first pressure control valves operatively connected to respective ones of the hydraulic actuators, and wherein said at least one second pressure control valve comprises a plurality of second pressure control valves operatively connected to respective ones of the hydraulic actuators.

21. The implement according to claim 1 wherein the ground working tools include first tools and second tools that are different from the first tools, and wherein the first and second pressure control valves that are associated with the frame sections having the first tools thereon are operated at different net biases forces relative to the first and second pressure control valves that are associated with the frame sections having the second tools thereon.

22. The implement according to claim 1 wherein each first pressure control valve is operatively connected to the first ports of a group of the hydraulic actuators in which the first ports of the hydraulic actuators within the group are in open communication with one another, and wherein each second pressure control valve is operatively connected to the second ports of the group of the hydraulic actuators in which the second ports of the hydraulic actuators within the group are in open communication with one another.

23. A towed agricultural implement comprising:
a tool bar;
ground wheels supporting the tool bar for movement across a ground surface in a forward working direction that is perpendicular to a longitudinal axis of the tool bar;
a plurality of frame sections movably mounted on the tool bar for movement in the forward working direction with the tool bar and carrying ground working tools for engaging the ground surface, each frame section being movably mounted on the tool bar by a respective operating linkage such that the frame section extends rearward from the tool bar and is movable up and down relative to the tool bar independently of other ones of the frame sections;
a hydraulic actuator operatively connected to each operating linkage, each hydraulic actuator including a first port operable to receive pressurized hydraulic fluid to lift the respective frame section relative to the tool bar and a second port operable to receive pressurized hydraulic fluid to lower the respective frame section relative to the tool bar; and
a hydraulic controller assembly including at least one pressure control valve operative to supply pressurized hydraulic fluid at a substantially constant, controlled pressure to one of the first or second ports port of each hydraulic actuator to exert a bias force to the frame sections, in which the controlled pressure is controllably adjustable by the hydraulic controller to vary the bias force exerted on the frame sections;
wherein said at least one pressure control valve includes a respective regeneration hydraulic line in communication between a controlled output of the pressure control valve and a regeneration valve, the regeneration valve being configured to allow excess pressure at the controlled output above the controlled pressure to be discharged from the controlled output through the regeneration line to another pressurized portion of the hydraulic controller.

24. The implement according to claim 23 wherein the regeneration valve of said at least one pressure control valve is configured to discharge the excess pressure of the pressure control valve to a pressure supply line supplying hydraulic fluid under pressure to the respective pressure control valve.

25. The implement according to claim 23 wherein said at least one pressure control valve includes a first pressure control valve and a second pressure control valve, and wherein the regeneration valve is configured to discharge the excess pressure at the controlled output of the first pressure control valve to the controlled output of the second pressure control valve of the hydraulic controller.

26. The implement according to claim 23 wherein the regeneration valve is arranged to discharge the excess pressure at the controlled output of the respective pressure control valve when the excess pressure exceeds the controlled pressured by an amount that is greater than a relief threshold of the regeneration valve.

27. A towed agricultural implement comprising:
a tool bar;
ground wheels supporting the tool bar for movement across a ground surface in a forward working direction that is perpendicular to a longitudinal axis of the tool bar;
a plurality of frame sections movably mounted on the tool bar for movement in the forward working direction with the tool bar and carrying ground working tools for engaging the ground surface, each frame section being movably mounted on the tool bar by a respective operating linkage such that the frame section extends rearward from the tool bar and is movable up and down relative to the tool bar independently of other ones of the frame sections;
a hydraulic actuator operatively connected to each operating linkage, each hydraulic actuator including a first port operable to receive pressurized hydraulic fluid to lift the respective frame section relative to the tool bar and a second port operable to receive pressurized hydraulic fluid to lower the respective frame section relative to the tool bar; and
a hydraulic controller assembly including (i) at least one pressure control valve operative to supply pressurized hydraulic fluid at a substantially constant, controlled pressure to one of the first or second ports port of each hydraulic actuator to exert a bias force to the frame sections in which the controlled pressure is controllably adjustable by the hydraulic controller to vary the bias force exerted on the frame sections;
wherein each operating linkage comprises a first link and a second link connected between the toolbar and the respective frame section, wherein the hydraulic actuator comprises a piston cylinder assembly connected between the first link of the operating linkage and one of (i) the second link and (ii) the respective frame section.

28. The implement according to claim 27 wherein the piston cylinder assembly is connected between the first link of the operating linkage and the respective frame section.

29. The implement according to claim 27 wherein the first link and the second link of each operating linkage are connected in parallel between the tool bar and the respective frame section, and wherein the first link is below the second link.

30. The implement according to claim 27 wherein the piston cylinder assembly extends at a downward and forward slope from the respective frame section to the first link throughout a range of motion of the respective frame section relative to the tool bar.
